(19) United States
(12) Patent Application Publication
(10) Pub. No.: US 2022/0307714 A1
(43) Pub. Date: Sep. 29, 2022

(54) Remote HVAC System Commissioning Verification Process, Utilizing Photograph Documentation of System Readings and Gauge Measurements, with Embedded Time, Date, and Geolocation Metadata Tags in Exchangeable Image File Format

(71) Applicant: Michael Charles Truitt, Fort Collins, CO (US)

(72) Inventor: Michael Charles Truitt, Fort Collins, CO (US)

(21) Appl. No.: 17/301,209

(22) Filed: Mar. 29, 2021

(51) Int. Cl. F24F 11/49; F24F 11/58; G06Q 10/00

(52) U.S. Cl. CPC F24F 11/49; F24F 11/58; G06Q 10/20; F24F 2140/60

(57) ABSTRACT

Methods of determining operational capacity and efficiency of HVAC systems remotely at the time of installation or service are provided. Heating and cooling capacity and efficiency is determined as a function of system parameters, comprising elements such as: gas combustion efficiency, supply airflow and return airflow temperature and humidity, blower-motor air-flow volume and electricity consumption, ductwork static-pressure, and refrigerant pressure and temperature. The method includes steps for installation or service technicians to follow industry best-practice procedures, and complete a system start-up checklist. Steps include measuring and adjusting heating and cooling system components according to manufacturer's specifications. Field technicians then transmit photographic documentation to a remote location where measurements and readings are used to determine and verify operational system capacity and efficiency.

### BACKGROUND AND PRIOR ART

Nationwide research studies spanning 25-years have confirmed that over 50% of HVAC systems in operation today are not properly installed or maintained according to HVAC equipment manufacturer's specifications, and fail to achieve rated capacity & potential efficiency. Numerous government and utility funded field-studies further estimate that upwards of 100-million HVAC systems in operation today have numerous technical system faults that reduce overall performance.

On an ongoing basis, HVAC contractors and technicians fail to properly design, install, set-up, adjust, and maintain HVAC equipment according to manufacturer's design specifications. Inefficiency and under-performance, by up to 30% is common, especially with split air-conditioning and heat pump systems. Errors and omissions made during installation and service also reduce system reliability and service life.

Prior efforts to verify HVAC system performance, in terms of capacity and efficiency, have been too expensive, time consuming, and difficult to scale. In many cases, these efforts have reduced compliance rather than improving outcomes. Additionally, the supply of trained technicians available to perform third-party verifications of HVAC system commissioning is quite inadequate. Failed attempts to verify HVAC commissioning and quality installations are numerous:

In 2014, California enacted Title-24, requiring third-party inspectors to verify quality HVAC installations. Follow-up outcome studies concluded that HVAC contractor compliance with the state permit system dropped from 80% to 10% due to the complexity and high costs of compliance. In addition, systems that were inspected by “third-party inspectors” hired directly by the HVAC contractors themselves, showed no statistical improvement in HVAC system performance versus systems that were not inspected and had avoided permit and testing compliance requirements altogether.

Likewise, Xcel Energy, serving Colorado gas and electricity customers, implemented a training and standards program for quality-installations of HVAC systems installed through their energy-efficiency rebate program in Colorado. HVAC contractors attended required trainings, and submitted commissioning forms which they themselves had completed. Xcel Energy's follow-up studies concluded the pass/fail rate for the approved participating contractors was indistinguishable from non-participating contractors, with about 50% failing in both cases.

Municipalities and utilities have repeatedly attempted to improve performance in the HVAC industry, through various training programs and agreements to follow standards for quality installations. However, follow-up studies conclude that; neither training alone, nor self-reported documentation improve results. Additionally, consumers are not willing to pay up front for expensive, time-consuming, and complex processes to improve outcomes if such processes increase cost substantially, and can be easily avoided.

The background description provided herein is for the purpose of generally presenting the context of the disclosure. Work of the presently named inventor, to the extent it is described in this background section, as well as aspects of the description that may not otherwise qualify as prior art at the time of filing, are neither expressly nor impliedly admitted as prior art against the present disclosure.

### SUMMARY & INVENTION ADVANTAGES

Consumers, contractors, municipal building departments, and utility-based energy-efficiency programs need a timely, inexpensive, accurate, and scalable process to verify installed HVAC system performance. By reducing the time, errors, and cost associated with quality-assurance compliance, the embodiment of remote commissioning verification enables wide-spread adaption of best-practices, and accountability for the HVAC industry.

Remote verified commissioning delivers improved HVAC system performance in less time at lower costs. Achieving scale, and increasing the number of quality installations of HVAC systems, benefits: consumers, contractors, and the environment. Optimizing HVAC & ductwork system performance reduces: energy use, pollution and carbon emissions, while also reducing utility expenses, and lifetime HVAC related maintenance costs. The embodiments thus create a less-expensive; less time-consuming, more accurate, and more scalable means of verifying HVAC system commissioning procedures.

### DETAILED DESCRIPTION OF THE EMBODIMENTS

The embodiments relate to the field of installing and maintaining building heating, cooling, and ventilation systems, and commissioning of those systems.

In the HVAC industry, the term commissioning refers to measuring, testing, adjusting, and calibrating of heating, cooling, and ventilation system components, in order to meet manufacturer's design specifications, and achieve optimized performance. Verifying when heating, cooling and ventilation equipment have been installed and maintained in accordance with manufacturer's specifications ensures operational efficiency, reliability and longevity of HVAC systems and equipment.

Certain embodiments include, but are not limited to a process for remotely verifying the installed operational capacity and efficiency of building heating, cooling, and ventilation systems, comprising of a series of tests performed by HVAC field technicians.

Other embodiments create a novel process, combining HVAC industry start-up and commissioning practices with photographic documentation uploaded by field technicians during installation or maintenance of HVAC systems. Photographs may be created, and uploaded or transmitted with: mobile devices, smart phones, tablets, PDAs, or laptops. Photographs are authenticated utilizing time, date, and geolocation data embedded in the photograph's exchangeable image file format metadata tags of said photographs.

Additional embodiments include the results of said tests submitted as photographs of analog or digital gauge readings, whereby measurements and values depicted in said photos are evaluated to be within the acceptable range of manufacturer's specifications.

Further embodiments include documentation of verified commissioning. Said documentation includes calculations of operational heating and cooling system capacity and efficiency, based on authenticated photographs of gauge measurements, and with said data from said measurements entered into standard and known industry formulas for said calculations.

### Operation and Procedures

Technicians complete the following measurement and adjustment checklist for HVAC equipment installations or maintenance, and document analog and digital-gauge readings with photographs. Verification of quality-installation and commissioning utilizes third-party expert evaluation of measurements depicted in photographs with verification of embedded date, time and location EXIF metadata tags, to prevent fraud and abuse of process. Measurements are used to calculate as-installed operational capacity and efficiency, as well as ensure other essential best-practice procedures.

A process for commissioning forced-air furnaces for heating, and photographing each gauge reading (with embedded time, date, location EXIF metadata) to be uploaded or transmitted for remote verification.
1. Measure gas-pressure (in inches water column): with analog or digital manometer connected to gas valve pressure check port, and take photo of gauge reading.
   Purpose of testing procedure: Gas-pressure should be within manufacture's specification range.
2. Measure carbon monoxide in parts per million: in highest-stage heating mode with digital gas-analyzer connected to flue exhaust gas venting, and take photo of gauge reading.
   Purpose: Higher carbon monoxide (CO) levels indicate incomplete combustion, and lower efficiency.
3. Measure indoor fan motor amps: check low-stage and high-stage heating fan motor amp draw with digital amp-meter connected to positive power wire, and take photo of gauge reading,
   Purpose: amperage measurements indicate higher or lower electricity consumption.
4. Measure temperature rise: with furnace in highest-stage heating, insert 1 digital thermometer into supply ductwork, and 1 digital thermometer in return ductwork, and take photos of gauge readings.
   Purpose: temperature delta affects heating output capacity, and should be within an acceptable range according to manufacturer's specifications.
5. Measure total external static pressure (TESP) in inches of water column (i.w.c.): insert probes connected to digital manometer into supply and return ductwork, and calculate TESP as follows: supply ductwork i.w.c.+absolute value of return ductwork i.w.c., and take photo of gauge reading.
   Purpose: static pressure affects airflow, system capacity, and blower motor electricity consumption.
6. Upload photo of manufacturer's data-plate and said gauge measurement photographs to online form for review and calculations of heating system installed output capacity & operational efficiency.
   Purpose: data-plate displays target measurements and manufacture's design specifications.
7. Submit remote third-party verification of quality-installation documentation for verified commissioning of HVAC system installed output capacity and operational efficiency,

continued next page:

A process for commissioning air-conditioners and heat pumps, and photographing each gauge reading (with embedded time, date, location EXIF metadata) to be uploaded or transmitted for remote verification:
8. Establish nitrogen-purge during brazing of refrigeration lines, and take photo of gauge readings.
   Purpose: brazing without utilizing a nitrogen purge allows for the buildup of black carbon inside refrigeration lines while brazing, which can later clog metering devices, blocking refrigerant flow and greatly impacting air-conditioning capacity and efficiency.
9. Measure evacuation/vacuum pump: gauge reading <500 microns, and take photo of gauge reading.
   Purpose: evacuation of refrigerant lines removes contaminants such as air and water from refrigeration systems. Contaminated refrigerant has a negative impact on cooling capacity and efficiency.
10. Measure total external static pressure (TESP) in inches of water column (i.w.c.): insert probes connected to digital manometer into supply and return ductwork, and calculate TESP as follows: supply ductwork i.w.c.+absolute value of return ductwork i.w.c., and take photo of gauge reading.
   Purpose: elevated static pressure reduces airflow needed for climate control, and significantly reduces both cooling capacity and efficiency while increasing electricity consumption of the blower fan motor.
11. Measure indoor fan motor amps: check low-stage and high-stage cooling fan motor amp draw with digital amp-meter connected to positive power wire, and take photo of gauge reading.
Purpose: amperage measurements indicate electricity consumption.
12. Measure temperature drop across evaporator coil: insert 1 digital thermometer into supply ductwork, and 1 digital thermometer in return ductwork, and take photos of gauge readings.
   Purpose: temperature delta affects cooling capacity, to be within manufacturer's specifications.
13. Measure Suction Line Temperature and Pressure: with digital thermometer on low-side vapor line, and digital pressure gauge attached to vapor line service valve, and take photo of gauge reading.
14. Measure Liquid Line Temperature and Pressure: with digital thermometer high-side liquid line, and digital pressure gauge attached to liquid line service valve, and take photo of gauge reading.
   Purpose of steps 13 and 14: refrigerant levels have a significant impact on cooling capacity for air-conditioners, and heating capacity for heat pumps.
15. Measure subcooling: refrigerant saturation temp—liquid line temp, and take photo of gauge reading.
   Purpose: refrigerant must be cooled below saturation for vapor to liquid phase change to occur, as the refrigeration cycle is heavily dependent on phase change to absorb and expel heat energy.
   Measure superheat: refrigerant saturation+vapor line temp, and take photo of gauge reading,
   Purpose: refrigerant must be heated above saturation for liquid to vapor phase change to occur, as the refrigeration cycle is heavily dependent on phase change to absorb and expel heat energy.
16. Measure CTOA (condenser temp over outside ambient temp), with digital dual-channel thermometer, or with two thermometers, and take photos of gauge readings.
   Purpose: temperature readings verified to be within range of manufacture's design specifications.
17. Measure Evaporator DTD (design return-air temp vs. evaporator coil temp), with digital dual-channel thermometer, or with two thermometers, and take photo of gauge reading.
   Purpose: temperature readings are verified to be within range of manufacture's design specifications.
18. Upload photo of manufacture's data-plate and cooling-mode gauge measurement photographs to online form for review and calculations of cooling system installed capacity & operational efficiency.
   Purpose: data-plate displays target measurements and manufacture's design specifications,
19. Submit remote third-party verification of quality-installation documentation for verified commissioning of 1-HVAC system installed output capacity and operational efficiency.

What is claimed is:

1. A method of remotely verifying the results of commissioning procedures for HVAC systems, said method comprising the steps:
a. Providing a field technician or inspector a checklist of start-up procedures, tests, and adjustments to perform on said HVAC system components, and comprising said commissioning procedure,
b. Said commissioning procedure results are documented using photographs taken with mobile devices, including cellular phone, smart phone, tablet, PDA, or laptop,
c. Said photographic documentation is comprised of displayed measurements taken by testing tools and gauges, and said photographs are embedded with time, date, and location metadata,
d. Receiving from a field technician or inspector said photographic documentation, by transmission to a remote location via cellular phone, smart phone, tablet, PDA, or laptop,
e. Said time, date, and location EXIF metadata tags are authenticated to confirm matching time, date, and location of said HVAC system commissioning tests and procedures,
f. Said measurements are determined to be within or beyond the acceptable range according to HVAC equipment manufacture's specifications, and utilized to calculate the output capacity and efficiency of heating or cooling systems, or both.
g. Whereby said commissioning procedures aim to optimize HVAC system performance, both in terms of installed output capacity and operational efficiency.
Whereby HVAC systems are remotely verified to be properly commissioned and optimized for output capacity and efficiency, or are identified as failing to meet manufacturer's specifications.
